(19) United States
(12) Patent Application Publication
(10) Pub. No.: US 2015/0132726 A1
(43) Pub. Date: May 14, 2015

(54) LANGUAGE LEARNING SYSTEM AND METHOD THEREOF

(71) Applicant: YU-CHUN HSIA, NEW TAIPEI CITY (TW)

(72) Inventor: YU-CHUN HSIA, NEW TAIPEI CITY (TW)

(21) Appl. No.: 14/522,698

(22) Filed: Oct. 24, 2014

(30) Foreign Application Priority Data
Nov. 11, 2013 (TW) 102140888

(51) Int. Cl. G09B 5/02; G09B 5/04; G09B 19/00

(52) U.S. Cl. CPC G09B 5/02; G09B 19/00; G09B 5/04
USPC 434/169

(57) ABSTRACT

A language learning system and a method thereof is provided, which creates a word database, a phrase database, and a sentence database. The phrases to be learned is identified based on the words the user learned before. The sentence to be learned is identified based on the words the user learned before, the phrases the user learned before, and the combination of the learned words and the learned phrases. That is, the words and phrases in the sentence to be learned are understood by the user. The sentence to be learned is shown in a list for the user to learn.

### FIELD OF THE INVENTION

The present invention is related to a language learning system and a method thereof, and more particularly related to a language learning system and a method thereof which searches the to-be-learned sentence based on the words and the sentence which the user has learned before.

### BACKGROUND OF THE INVENTION

Generally, a student usually learns a language through the help of content in the dictionaries and the textbooks. When encountering unfamiliar words or phrases, the major strategy is to do the learning based on student's preliminary understanding of the words and phrases, the interpretation of the teacher, and also with the help of illustrated sentences. However, it is difficult to accumulate language ability merely based on the practices of words, phrases, and sentences. The learning is time costly and exhausted, which makes it difficult to maintain the motive of language learning, and thus, people with good language expression and writing skills are quite admirable.

In addition, the expression ability of student is restricted by the illustrated sentences listed on the textbook even though most of the words and phrases are well learned. However, the combination of the learned words and phrases can derive lots of illustrated sentences which are much more that what has been listed on the textbook, and there should be some useful illustrated sentences suitable for the student to learn. That is, the students cannot thoroughly learn the illustrated sentences based on every combination of the learned words and phrases. Because the words and phrases are learned without being aware of the insufficiency, the student might not be able to use the learned words and phrases properly and thus the language ability would be restricted. Meanwhile, with the help of computer technology, many computer aided language learning materials have been developed. However, most of the learning materials just provide a large number of unchangeable content or item pools for repeatedly practicing, however, these learning materials cannot provide a chance of more expansive learning.

### BRIEF SUMMARY OF INVENTION

In views of the traditional language learning method, which cannot help student to learn language with efficiency and provide the chance of a more expansive learning, and thus the students usually learn the words and phrases without being aware of the insufficiency such that the students might not be able to use the learned words and phrases properly to compose a better sentence. As a result, language expression and writing ability of the student in present cannot have significant improvement.

Accordingly, it is a main object of the present invention to provide a language learning system and a method thereof, which searches the to-be-learned sentence based on the learned words and the learned phrases, such that the searched to-be-learned sentence would be made of words and phrases which the learner has learned before.

According to the object mentioned above, a language learning system is provided in accordance with the present invention. The language learning system comprises a word database, a phrase database, a sentence database, a searching module, and a displaying module. The word database stores a plurality of words including a plurality of learned words and a plurality of to-be-learned words. The phrase database stores a plurality of phrases made of the words. The sentence database stores a plurality of sentences, which are made of the words and the phrases, and the sentences include a plurality of to-be-learned sentences. The searching module is electrically connected to the word database, the phrase database, and the sentence database, for searching at least one of the phrases from the phrase database according to at least one of the to-be-learned words inputted by a learner and the learned words, and further for searching at least one of the to-be-learned sentences from the sentence database according to the learned words, the inputted at least one of the to-be-learned words, and the searched at least one phrase so as to generate a list according to the at least one to-be-learned sentence, wherein the at least one to-be-learned sentences is made of the learned words, the inputted to-be-learned word, and the searched at least one phrase. The displaying module is electrically connected to the searching module for displaying the list for the learner to learn.

In addition, a language learning method is also provided in accordance with the present invention, which comprises the steps of: (a) building a word database, which stores a plurality of words including a plurality of learned words and a plurality of to-be-learned words; (b) building a phrase database, which stores a plurality of phrases made of the words; (c) building a sentence database, which stores a plurality of sentences, which are made of the words and the phrases, and the sentences including a plurality of to-be-learned sentences; (d) inputting at least one of the to-be-learned words; (e) searching at least one of the phrases from the phrase database according to the at least one of the to-be-learned words inputted in the step (d) and the learned words; (f) searching at least one of the to-be-learned sentences from the sentence database according to the learned words, the to-be-learned word inputted in the step (d), and the at least one phrase searched in the step (e), wherein the at least one of the to-be-learned sentences is made of the learned words, the inputted to-be-learned word, and the searched at least one phrase; and (g) generating a list including the at least one to-be-learned sentence searched in the step (f) for a learner to learn.

In accordance with a preferred embodiment of the language learning system and the method thereof provided in the present invention, the sentences further comprises a plurality of learned sentences, and as the at least one to-be-learned sentence on the list is marked as learned, the at least one to-be-learned sentence would be identified as the learned sentence and removed from the list. In addition, the words are shown by using data selected from a group including audio data, phonetic symbol, and explaining material to the learner, the phrases are shown by using data selected from a group including audio data, phonetic symbol, explaining material, similar phrases, and opposite phrases to the learner, and the sentences are shown by using data selected from a group including audio data, phonetic symbol, explaining material, video, keyword annotation, verb annotation, and adjective annotation. Moreover, other than those common sentences, the sentences in the sentence database are sorted by topic, area of expertise, type of article, and type of sentences.

In accordance with a preferred embodiment of the present invention, the language learning system and the method thereof further comprises an article database electrically connected to the searching module. The article database stores a plurality of articles, which includes a plurality of to-be-learned articles, one of the to-be-learned articles is made of at least one of the to-be-learned words, at least one of the learned words, and at least one of the phrases, and the searching module searches the to-be-learned article with the at least one of the to-be-learned words according to the at least one of the learned words and the at least one of the phrases. In addition, these articles are shown to the learner by using audio data, explaining material, and video, and the articles in the article database are sorted by topic, area of expertise, and type of article.

In accordance with a preferred embodiment of the present invention, the language learning system and the method thereof further comprises a dialogue database electrically connected to the searching module. The dialogue database stores a plurality of dialogues, which includes a plurality of to-be-learned dialogues, one of the to-be-learned dialogues is made of the at least one of the to-be-learned words, the at least one of the learned words, and the at least one of the phrases, and the searching module searches the to-be-learned dialogue with the at least one of the to-be-learned words according to the at least one of the learned words and the at least one of the phrases. In addition, the dialogues are shown to the learner by using audio data, explaining material, and video, and the dialogues in the dialogue database are sorted by topic, area of expertise, and type of dialogue.

With the help of the language learning system and the language learning method provided in the present invention, a concentrated learning environment can be provided to the learner immediately because the sentence database, the article database, and the dialogue database built in accordance with the present invention are searched based on learned words and phrases so as to locate the to-be-learned sentence without any words or any phrases which the learner has not learned before from the sentence database, the to-be-learned article without any words or any phrases which the learner has not learned before from the article database, and the to-be-learned dialogue without any words or any phrases which the learner has not learned before from the dialogue database respectively. That is, the system can automatically and fully simulate the subconscious works in human brain of creatively arranging words and phrases to express rich ideas of language in real time. Such ability can only be acquired through long term massive reading.

In addition, because the system generates the personal learning materials according to the loading order of the learned words and phrases, the newly learned words and phrases will appear in the learning material in high frequency so as to achieve the effect of automatic concentrated reviewing and build up the memory links of the sentences with order. In addition, it is also helpful for the learner to get used to the special words and expression of a specific area of expertise in short time.

Moreover, because the system will search the sentence database, the article database, and the dialogue database to list various useful examples of all the sentences, articles, and dialogues composed of learned words and phrases as the newly learned words and phrases are inputted, the learner can fully access the situations of use, the ways of use, and the definitions of the words and phrases. Thus, the student can enhance his learning efficiency and improve his language ability accordingly.

The embodiments adopted in the present invention would be further discussed by using the flowing paragraph and the figures for a better understanding.

### BRIEF DESCRIPTION OF THE DRAWINGS

FIG. 1 is a block diagram showing the language learning system in accordance with a first embodiment of the present invention.

FIG. 2 is a flowing chart showing the language learning method in accordance with the first embodiment of the present invention.

FIG. 3 is a schematic view showing the word database in accordance with the first embodiment of the present invention.

FIG. 4 is a schematic view showing the phrase database in accordance with the first embodiment of the present invention.

FIG. 5 is a schematic view showing the sentence database in accordance with the first embodiment of the present invention;

FIG. 6 is a schematic view showing the list in accordance with the first embodiment of the present invention.

FIG. 7 is a schematic view showing the list in accordance with a second embodiment of the present invention.

FIG. 8 is a schematic view showing the list in accordance with a third embodiment of the present invention.

FIG. 9 is a block diagram showing the article database and the dialogue database in accordance with another embodiment of the language learning system of the present invention.

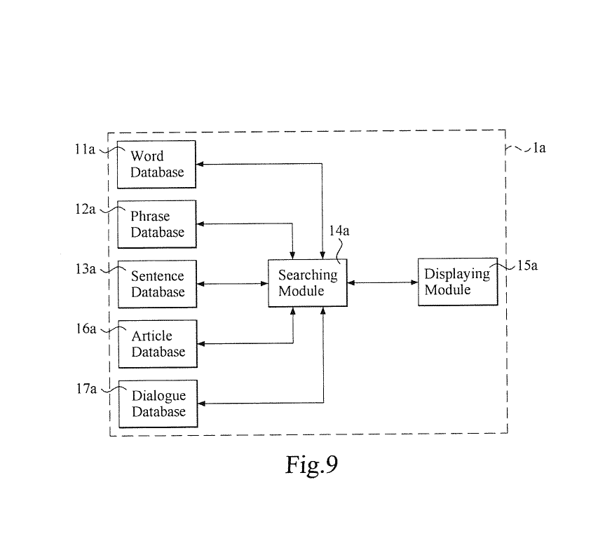

### DETAILED DESCRIPTION OF THE INVENTION

There are various embodiments of the language learning system and the method thereof provided in accordance with the present invention, which are not repeated hereby. Only three preferred embodiments are mentioned in the following paragraph as examples.

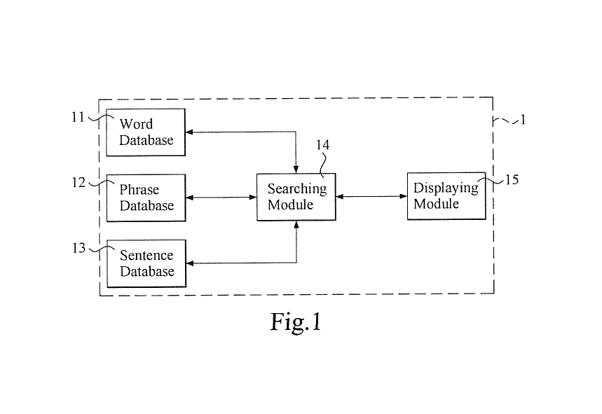

FIG. 1 is a block diagram showing the language learning system in accordance with a first embodiment of the present invention. As shown, the language learning system 1 provided in the present invention includes a word database 11, a phrase database 12, a sentence database 13, a searching module 14, and a displaying module 15.

The language learning system 1 can be set in an electronic device, such as an electronic dictionary, a computer, a smart phone, and etc. Concretely speaking, the word database 11, the phrase database 12, and the sentence database 13 may be enabled by a memory, such as the Erasable Programmable Read Only Memory (EPROM) or the Non-Volatile Memory (NVRAM) of the flash memory.

The searching module 14 is electrically connected to the word database 11, the phrase database 12, and the sentence database 13, and can be enabled by ICs with processing ability, such as micro-processors. The displaying module 15 is electrically connected to the searching module 14, which can be a flat panel display such as a liquid crystal display (LCD), a light emitting diode (LED) display, or active matrix organic light-emitting diode (AMOLED) display. However, the present invention is not so restricted.

In addition, the language learning system 1 provided in accordance with the present invention can also be used in distance education. For example, the word database 11, the phrase database 12, the sentence database 13, and the searching module 14 can be arranged in a remote server (not shown) provided by the service provider and the display module 15 can be a learner's computer, tablet, smart phone, or personal digital assistant (PDA). However, the present invention is not so restricted.

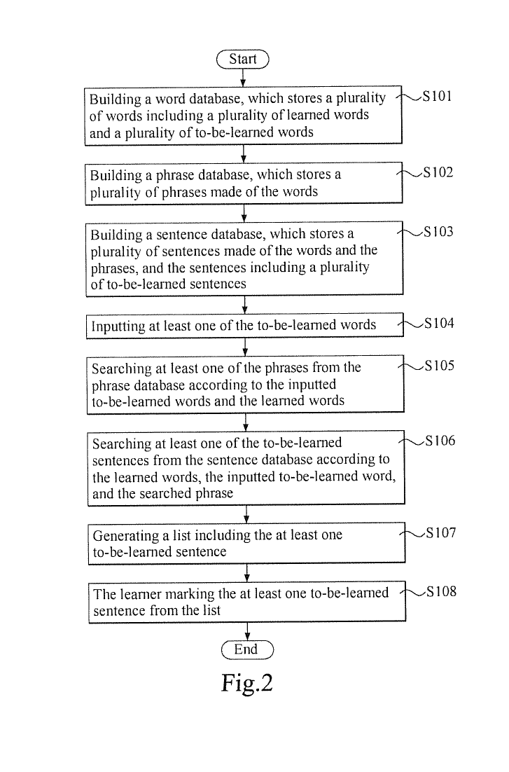

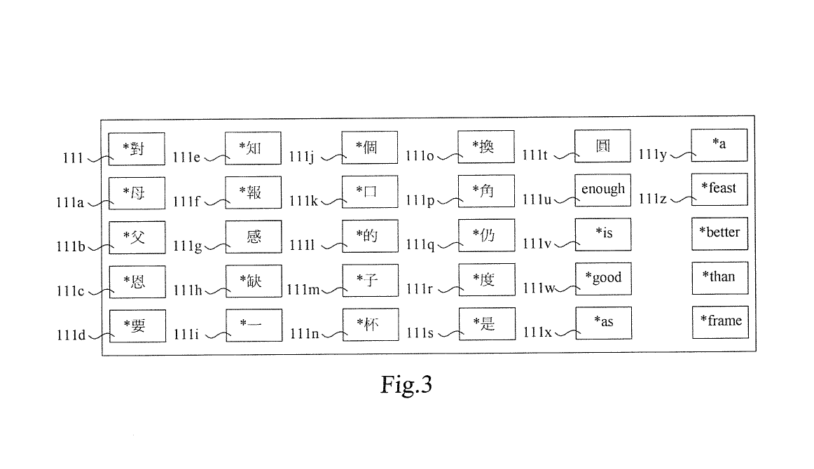

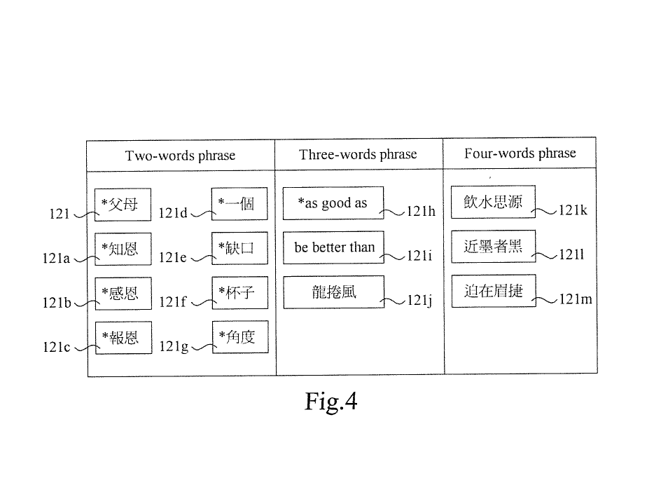

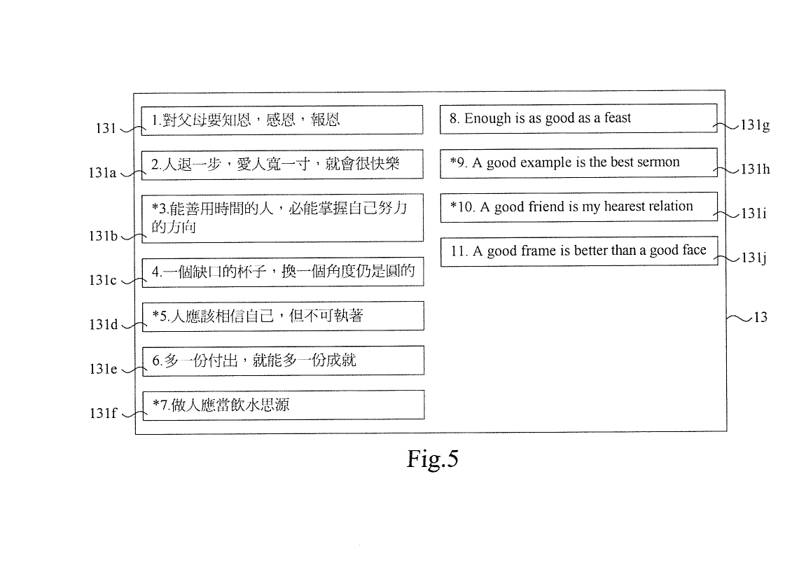

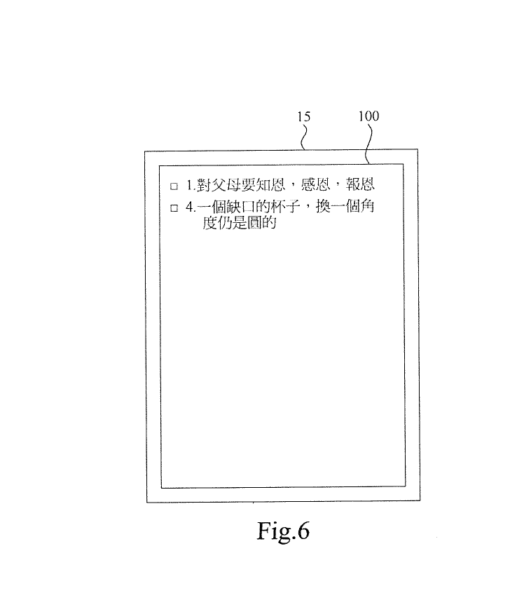

For a better understanding of the operating relationship between the word database 11, the phrase database 12, the sentence database, 13, the searching module 14, and the displaying module 15, the present embodiment would be further discussed together with the process of the language learning method provided in accordance with the present invention. Please refer to FIG. 1 to FIG. 6, wherein FIG. 2 is a flowing chart showing the language learning method in accordance with the first embodiment of the present invention; FIG. 3 is a schematic view showing the word database in accordance with the first embodiment of the present invention; FIG. 4 is a schematic view showing the phrase database in accordance with the first embodiment of the present invention; FIG. 5 is a schematic view showing the sentence database in accordance with the first embodiment of the present invention; and FIG. 6 is a schematic view showing the list in accordance with the first embodiment of the present invention. As shown, the language learning method comprises the steps of:

Step S101: building a word database, which stores a plurality of words including a plurality of learned words and a plurality of to-be-learned words;

Step S102: building a phrase database, which stores a plurality of phrases made of the words;

Step S103: building a sentence database, which stores a plurality of sentences made of the words and the phrases, and the sentences including a plurality of to-be-learned sentences;

Step S104: inputting at least one of the to-be-learned words;

Step S105: searching at least one of the phrases from the phrase database according to the inputted to-be-learned words and the learned words;

Step S106: searching at least one of the to-be-learned sentences from the sentence database according to the learned words, the inputted to-be-learned word, and the searched phrase;

Step S107: generating a list including the at least one to-be-learned sentence; and

Step S108: the learner marking the at least one to-be-learned sentence from the list.

As the process started, the step S101 executed to build a word database, which stores a plurality of words including a plurality of learned words and a plurality of to-be-learned words. In the present step, the word database 11 is built up to store a plurality of words 111-111z. Concretely speaking, the definition of “word” in the present invention indicates a single word in Chinese, i.e. the words 111-111t shown in FIG. 3. It is noted that the small amount of words shown in the present embodiment are merely for the purpose of illustrating. In practice, when building the word database 11 in Chinese, at least 7000 words can be included. In addition, the “word” being used in the present invention should be regarded as a word with definite meaning in English. In practice, when building the word database 11 in English, i.e. the words 111u-111z shown in FIG. 3, at least 20000 words can be included.

It should be noted that, these words include the words which the learner has learned before, i.e. the learned words, and the words which the learner has not learned before, i.e. the to-be-learned words. According to the illustration of the first embodiment of the present invention, words 111-111f, 111h-111s, and 111v-111z are the learned words and words 111g, 111t, and 111u are the to-be-learned words. The learned words and the to-be-learned words can be represented by colors or labels. However, the present invention is not so restricted. In addition, these words 111-111z can be shown by means of audio data, phonetic notation, and explaining material for the learner to learn. However, the present invention is not so restricted.

After the step S101, the step S102 is carried out to build a phrase database, which stores a plurality of phrases made of the above mentioned words. That is, in the present step, the phrase database 12 is built to store the phrases 121-121m as shown in FIG. 4. It is noted that the small amount of phrases shown in the present embodiment are merely for the purpose of illustrating. In practice, when building the phrase database 12, at least 40000 phrases can be included.

Concretely speaking, the definition of “phrase” in the present invention indicates a composition made of two or more words, in both Chinese and English. Thus, the phrases stored in the phrase database 12 can further be sorted as “two-words phrase”, “three-words phrase”, “four-words phrase”, or more, and the phrase should possess its own meaning. Similarly, the phrases stored in the phrase database 12 include the phrases which the learner has learned before, i.e. the learned phrases, and the phrases which the learner has not learned before, i.e. the to-be-learned phrases. According to the illustration of the first embodiment of the present invention, phrases 121, 121a-121h are the learned phrases, and phrases 121i-121m are the to-be-learned phrases. The learned phrases and the to-be-learned phrases can be represented by colors or labels. However, the present invention is not so restricted. In addition, these phrases 121-121m can be shown by means of audio data, phonetic notation, explaining material, similar phrases, and opposite phrases for the learner to learn. However, the present invention is not so restricted.

After the step S102, the step S103 is carried out to build a sentence database, which stores a plurality of sentences made of the above mentioned words and phrases, and the sentences include a plurality of to-be-learned sentences. That is, in the present step, the sentence database 13 is further built to store a plurality of sentences 131-131j. Concretely speaking, the definition of “sentence” in the present invention indicates the sentences made of the words in the word database 11 and the phrases in the phrase database 13 in both Chinese and English, such as the sentences 131-131j shown in FIG. 5. It is noted that the small amount of sentences shown in the present embodiment are merely for the purpose of illustrating. In practice, when building the sentence database 13, at least hundreds of thousand sentences can be included. In addition, the sentences in the sentence database 13 can be selected from the existed famous quotations, or other meaningful and practical sentences.

In addition, it is noted that the sentences in the sentence database 13 may include the sentences which the learner has not learned before, i.e. the to-be-learned sentences and the sentences which the learner has learned before, i.e. the learned sentences. The learned sentences and the to-be-learned sentences can be represented by colors or labels. However, the present invention is not so restricted. In FIG. 5, the learned sentences are labeled by “*”. That it, the sentences 131, 131a, 131c, 131e, 131g, and 131j are the to-be-leaned sentences, and the sentences 131b, 131d, 131f, 131h, and 131i are the learned sentences. In addition, these sentences can be stored in the sentence database 13 by ranking.

In addition, these sentences 131-131j can be shown by means of audio data, phonetic notation, explaining material, video data, keyword notation, verb notation, and adjective notation for the learner to learn. However, the present invention is not so restricted. The detail of how the learned words, phrases, and sentences are generated would be further discussed in the following paragraphs.

After the step S103, the step S104 is carried out to input at least one of the to-be-learned words. In the present step, the learner may use the input unit (not shown), such as keyboard, to input at least one of the to-be-learned words of the word database 11. In the first embodiment of the present invention, the words 111g and 111t as shown in FIG. 3 are inputted.

The above mentioned to-be-learned words may be inputted by typing or marking the specific word from the list. The to-be-learned word may be a newly learned word, which the learner wants to have a deeper learning from the sentences, articles, or dialogues, which do not include any fresh words or phrases that the learner has not learned before, to have a better understanding of the situations of use, the ways of use, and the definition of the words. In addition, the to-be-learned word may be a fresh one, which the learner wants to learn the situations of use, the ways of use, and the definition of the word from the sentences, articles, and dialogues in which the specific word is the only fresh word that the learner has not learned before.

After the step S104, the step S105 is carried out to search at least one of the phrases from the phrase database according to the learned words and the inputted to-be-learned words. In the present step, the searching module 14 searches the phrases 121-121g from the phrase database 12 according to the combination of the learned words 111-111f and 111h-111s and the inputted to-be-learned words 111g and 111t. Concretely, for example, the combination of words 111a and 111b can derive the phrase 121, the combination of word 111c as well as the words 111e, 111f, and 111g respectively can derive the phrases 121a, 121b, and 121c, and so forth, which are not repeated here.

After the step S105, the step S106 is carried out to search at least one of the to-be-learned sentences from the sentence database according to the learned words, the inputted to-be-learned words, and the searched phrases. In the present step, the searching module 14 searches the sentences 131 and 131c from the to-be-learned sentences 131, 131a, 131c, 131e, 131g, and 131j of the sentence database 13 according to the combination of the learned words 111-111f and 111h-111s, the to-be-learned words 111g and 111t inputted in step S104, and the phrases 121-121g searched in step S105. Furthermore, the to-be-learned sentence 131 is made of the learned words 111 and Ill d, the learned phrases 121, 121a, 121b, and 121c, and the to-be-learned sentence 131c is made of the learned words 111l, 111o, 111q, and 111s, the to-be-learned word 111t, and the learned phrases 121d, 121e, 121f, and 121g. As mentioned, because the to-be-learned sentences 131 and 131c are composed of the words and the phrases the learner has learned before, there should be no unknown words or phrases in the sentences such that the learner can learn the different combination of the words and the phrases, and also the different ways of using the words and the phrases.

After the step S106, the step S107 is carried out to generate a list including the searched at least one to-be-learned sentence. In the present step, the searching module 14 transmits the searching result to the displaying module 15 so as to have the displaying module 15 showing the list 100 as shown in FIG. 6, which displays the to-be-learned sentences 131 and 131c searched in step S106 and further shows the ranks and items capable to be marked before the to-be-learned sentences 131 and 131c.

After the step S107, the step S108 is carried out in which the learner marks the above mentioned at least one to-be-learned sentence in the list. In the present step, the learner may mark the to-be-learned sentences 131 and 131c as learned ones after make sure that he fully understands the to-be-learned sentences 131 and 131c. The marking process will simultaneously change the data in the sentence database 13 to label the to-be-learned sentences 131 and 131c as “*” and change them as learned ones such that if the learner input the same words 111-111t at the next time, the to-be-learned sentences 131 and 131c would not be shown on the list 100 again. In addition, it is noted that, both the learned words and the learned phrases can be classified by marking.

Moreover, in accordance with another embodiment of the present invention, a recording module (not shown) can be used to electrically connect to the searching module 14 for recording the order of the words being inputted by the learner and the frequently inputted words. That is, the learner can record the order of the inputted words and the frequently inputted words each time such that the searching module 14 can rank the searched result in the list (not shown) based on the order or the frequency (i.e. the sentences with high frequency words are list in front). However, the present invention is not so restricted. In addition, the recording module may also record the words which the learner have inputted before and the to-be-learned sentences without being marked by the learner, such that as the learner inputs the same word next time, the searching module 14 can list the unmarked to-be-learned sentences directly without the need of searching the same words.

In addition, in accordance with another embodiment of the present invention, a question database (not shown) may be used to electrically connect to the searching module 14 to store questions. After the step S108, the searching module 14 can further have the questions related to the learned sentences shown on the displaying module 15 for the learner to learn so as to make sure that the learner does understand the learned sentences.

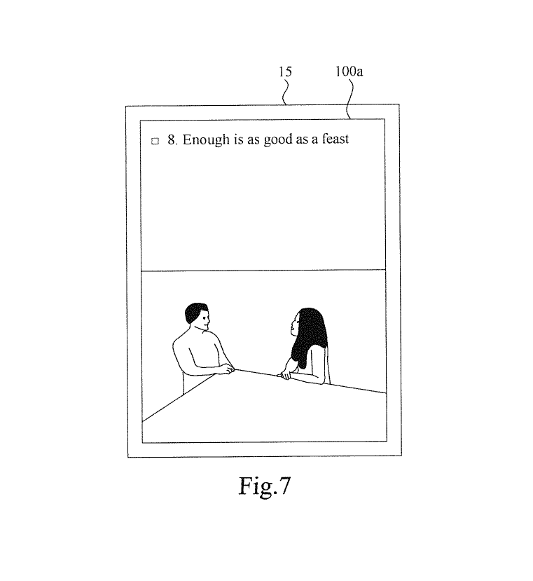

Take English for example, please refer to FIG. 1 to FIG. 5, and FIG. 7, wherein FIG. 7 is a schematic view showing the list in accordance with a second embodiment of the present invention. As shown, after the learner inputs the to-be-learned word 111u in step S104, the searching module 14 searches the learned phrase 121h in the phrase database 12 according to the combination of the words 111u-111z. After the step S105, the searching module 14 searches the to-be-learned sentence 131g in the sentence database 13 in step S106 according to the combination the learned words 111v-111z, the to-be-learned word 111u, and the learned phrase 121h. Thereafter, in the step S107, after the searching result is generated, a list 100a is generated on the displaying module 15 to show the to-be-learned sentence 131g and the corresponding video for the learner to learn. The other portions of the present embodiment are identical to the first embodiment and thus are not repeated here.

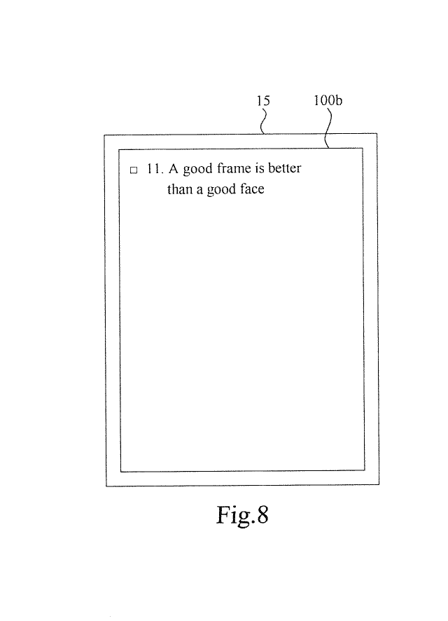

In addition, in the above mentioned embodiments, the one of the to-be-learned sentences 131, 131a, 131c, 131e, 131g, and 131j is made of one of the to-be-learned words 111g, 111t, and 111u, at least one of the learned words 111-111f, 111h-111s, and 111v-111z, and at least one of the phrases 121-121m. Furthermore, as shown in FIG. 8, in which please refer to FIG. 1 for the labels and FIG. 3 to FIG. 5 for the words, the phrases, and the sentences. FIG. 8 is a schematic view showing the list in accordance with a third embodiment of the present invention. As shown, the present embodiment is different from the first embodiment that after the step S108, the present embodiment further comprises a step of searching the specific to-be-learned sentence including one of the to-be-learned words from the to-be-learned sentences according to at least one of the learned words and at least one of the phrases.

Concretely speaking, the searching module 14 searches the to-be-learned sentence with only one to-be-learned word from the to-be-learned sentences 131, 131a, 131c, 131e, 131g, and 131j. In the present embodiment, the to-be-learned sentence 131j, which has only one to-be-learned word “face”, is identified to generate the list 100b as shown in FIG. 8. Thereby, the learner can learn the sentence with only one to-be-learned word and the specific word by backward learning so as to achieve the effect of increase learning efficiency.

In addition, in accordance with another embodiment of the present invention, a step of determining if the to-be-learned phrase can be found from the phrases may be interposed between the step S105 and the step S106. If the answer is not, the step S106 would be executed directly; whereas, if the answer is yes, the to-be-learned phrase would be listed and an additional step of determining if the to-be-learned phrases should be marked as learned phrase would be executed. Then, if the answer is not, the step S106 would be executed directly and the to-be-learned phrases would be remained in the to-be-learned state such that these to-be-learned phrases will be listed in the next time. If the answer is yes, the step S106 would be also executed directly, however, these to-be-learned phrases would be changed as learned ones such that these changed phrases will not be listed in the next time.

Other than the above mentioned embodiments, in accordance with the fourth embodiment of the present invention, in addition to the word database 11a, phrase database 12a, and sentence database 13a, a step of building an article database 16a electrically connected to the searching module 14 can be added between step S103 and step S104. The article database 16a stores a plurality of articles including a plurality of to-be-learned articles. One of the to-be-learned articles is made of at least one of the to-be-learned words, at least one of the learned words, and at least one of the phrases. Concretely speaking, these articles can be a short fable or an essay, in which only several words (such as two or three words) that the learner has not learned before.

Thus, in the fourth embodiment of the present invention, a step of searching the to-be-learned article with at least one of the to-be-learned words according to at least one of the learned words and at least one of the phrases is adopted after the step S108. Furthermore, the idea is to search the article with only a small amount of words which the learner has not learned before according to the words and the phrases which the learner has learned before. In addition, in the fourth embodiment, the searching step may also search the articles merely composed of learned words and learned phrases for the learner to learn just like the condition of the first embodiment.

In addition, in the fourth embodiment, these articles are shown by means of audio data, explaining material, and video data. Take the video data for example, the list may show the video data and the articles included in the dialogue of the video such that the learner can learn the accent, the expression, and the tone of speaking so as to improve his language ability. Other than the essays and the short stories, these articles may also include the documents such as news articles, audio books, and dialogues in the movie. In addition, the articles in the article database can be sorted by topic, area of expertise, and type of article.

Other than the above mentioned fourth embodiment, in accordance with the fifth embodiment of the present invention, in addition to the word database 11a, phrase database 12a, the sentence database 13a, and the article database 16a, a step of building a dialogue database 17a electrically connected to the searching module 14 can be added after the step S103 but before the step S104. The dialogue database 17a stores a plurality of dialogues including a plurality of to-be-learned dialogues. One of the to-be-learned dialogues is made of at least one of the to-be-learned words, at least one of the learned words, and at least one of the phrases. Concretely speaking, the dialogue can be a short daily conversation, in which only several words (such as two or three words) which the learner has not learned before.

Thus, in the fifth embodiment of the present invention, a step of searching the to-be-learned dialogue including at least one of the to-be-learned words according to at least one of the learned words and at least one of the phrases is adopted after the step S108. Furthermore, the idea is to search the dialogue with only a small amount of words which the learner has not learned before according to the words and the phrases which the learner has learned before. In addition, in the fifth embodiment, the searching step may also search the dialogue merely composed of learned words and learned phrases just like the condition of the first embodiment.

In addition, in the fifth embodiment, these dialogues are shown by means of audio data, explaining material, video data, and characters for the learner to learn, and the dialogues in the dialogue database can be sorted by topic, area of expertise, and type of article.

In sum, with the help of the language learning system 1 and the language learning method provided in the present invention, a concentrated learning environment can be provided to the learner immediately because the sentence database 13, i.e. a dictionary of articles, built in accordance with the present invention is searched based on learned words and phrases so as to locate the to-be-learned sentence without any words or any phrases which the learner has not learned before from the dictionary of articles. That is, the system can automatically and fully simulate the subconscious works in human brain of creatively arranging words and phrases to express rich ideas of language in real time. Such ability can only be acquired through long term massive reading.

In addition, because the system generates the personal learning materials according to the loading order of the learned words and phrases, the newly learned words and phrases will appear in the learning material in high frequency so as to achieve the effect of automatic concentrated reviewing and build up the memory links of the sentences with order. In addition, it is also helpful for the learner to get used to the special words and expression of a specific area of expertise in short time.

Moreover, because the system will search the sentence database, the article database, and the dialogue database to list various useful examples of all the sentences, articles, and dialogues composed of learned words and phrases as the newly learned words and phrases are inputted, the learner can fully access the situations of use, the ways of use, and the definitions of the words and phrases. Thus, the student can enhance his learning efficiency and improve his language ability accordingly.

The detail description of the aforementioned preferred embodiments is for clarifying the feature and the spirit of the present invention. The present invention should not be limited by any of the exemplary embodiments described herein, but should be defined only in accordance with the following claims and their equivalents. Specifically, those skilled in the art should appreciate that they can readily use the disclosed conception and specific embodiments as a basis for designing or modifying other structures for carrying out the same purposes of the present invention without departing from the scope of the invention as defined by the appended claims.

We claim:

1. A language learning system, comprising:
a word database, storing a plurality of words including a plurality of learned words and a plurality of to-be-learned words;
a phrase database, storing a plurality of phrases made of the words;
a sentence database, storing a plurality of sentences made of the words and the phrases, and the sentences including a plurality of to-be-learned sentences;
a searching module, electrically connected to the word database, the phrase database, and the sentence database, for searching at least one of the phrases from the phrase database according to at least one of the to-be-learned words inputted by a learner and the learned words, and further for searching at least one of the to-be-learned sentences from the sentence database according to the learned words, the inputted at least one of the to-be-learned words, and the searched at least one phrase so as to generate a list according to the at least one to-be-learned sentence, wherein the at least one to-be-learned sentences is made of the learned words, the inputted to-be-learned word, and the searched at least one phrase; and
a displaying module, electrically connected to the searching module for displaying the list for the learner to learn.

2. The language learning system of claim 1, wherein the words are shown by using data selected from a group including audio data, phonetic symbol, or explaining material to the learner, the phrases are shown by using data selected from a group including audio data, phonetic symbol, explaining material, similar phrases, or opposite phrases to the learner, the sentences are shown by using data selected from a group including audio data, phonetic symbol, explaining material, video data, keyword annotation, verb annotation, or adjective annotation to the learner, and the sentences in the sentence database are sorted by topic, area of expertise, type of article, and type of sentences.

3. The language learning system of claim 1, wherein the one of the to-be-learned sentences is made of the one of the to-be-learned words, the at least one of the learned words, and the at least one of the phrases, and the searching module searches the to-be-learned sentence including the one of the to-be-learned words according to the at least one of the learned words and the at least one of the phrases.

4. The language learning system of claim 1, further comprising an article database electrically connected to the searching module, wherein the article database stores a plurality of articles, which includes a plurality of to-be-learned articles, one of the to-be-learned articles is made of at least one of the to-be-learned words, at least one of the learned words, and at least one of the phrases, and the searching module searches the to-be-learned article with the at least one of the to-be-learned words according to the at least one of the learned words and the at least one of the phrases.

5. The language searching system of claim 4, wherein the articles are shown by using data selected from a group including audio data, explaining material, and video data, and the articles in the article database are sorted by topic, area of expertise, and type of article.

6. The language learning system of claim 1, further comprising a dialogue database, wherein the dialogue database stores a plurality of dialogues, which includes a plurality of to-be-learned dialogues, one of the to-be-learned dialogues is made of at least one of the to-be-learned words, at least one of the learned words, and at least one of the phrases, and the searching module searches the to-be-learned dialogue with the at least one of the to-be-learned words according to the at least one of the learned words and the at least one of the phrases.

7. The language searching system of claim 6, wherein the articles are shown by using the data selected from a group including audio data, explaining material, and video data, and the articles in the article database are sorted by topic, area of expertise, and type of dialogue.

8. A language learning method, comprising the steps of:
(a) building a word database, which stores a plurality of words including a plurality of learned words and a plurality of to-be-learned words;
(b) building a phrase database, which stores a plurality of phrases made of the words;
(c) building a sentence database, which stores a plurality of sentences, which are made of the words and the phrases, and the sentences including a plurality of to-be-learned sentences;
(d) inputting at least one of the to-be-learned words;
(e) searching at least one of the phrases from the phrase database according to the at least one of the to-be-learned words inputted in the step (d) and the learned words;
(f) searching at least one of the to-be-learned sentences from the sentence database according to the learned words, the to-be-learned word inputted in the step (d), and the at least one phrase searched in the step (e), wherein the at least one of the to-be-learned sentences is made of the learned words, the inputted to-be-learned word, and the searched at least one phrase; and
(g) generating a list including the at least one to-be-learned sentence searched in the step (f) for a learner to learn.

9. The language learning method of claim 8, wherein the words are shown by using data selected from a group including audio data, phonetic symbol, and explaining material to the learner, the phrases are shown by using data selected from a group including audio data, phonetic symbol, explaining material, similar phrases, and opposite phrases to the learner, the sentences are shown by using data selected from a group including audio data, phonetic symbol, explaining material, video data, keyword annotation, verb annotation, adjective annotation to the learner, and the sentences in the sentence database are sorted by topic, area of expertise, type of article, and type of sentences.

10. The language learning method of claim 8, wherein the one of the to-be-learned sentences is made of the one of the to-be-learned words, the at least one of the learned words, and the at least one of the phrases, and further comprising a step (h) after the step (g) to search the to-be-learned sentence with the one of the to-be-learned words from the to-be-learned sentences according to the at least one of the learned words and the at least one of the phrases.

11. The language learning method of claim 8, further comprising a step (c1) after the step (c) and before the step (d) to build an article database, wherein the article database stores a plurality of articles, which includes a plurality of to-be-learned articles, one of the to-be-learned articles is made of at least one of the to-be-learned words, at least one of the learned words, and at least one of the phrases, and further comprising a step (i) after the step (g) to search the to-be-learned article with the at least one of the to-be-learned words according to the at least one of the learned words and the at least one of the phrases.

12. The language searching method of claim 11, wherein the articles are shown by using the data selected from a group including audio data, explaining material, and video data, and the articles in the article database are sorted by topic, area of expertise, and type of article.

13. The language learning method of claim 8, further comprising a step (c2) after the step (c) and before the step (d) to build a dialogue database, wherein the dialogue database stores a plurality of dialogues, which includes a plurality of to-be-learned dialogues, one of the to-be-learned dialogues is made of the at least one of the to-be-learned words, the at least one of the learned words, and the at least one of the phrases, and further comprising a step (j) after the step (g) to search the to-be-learned dialogue with the at least one of the to-be-learned words according to the at least one of the learned words and the at least one of the phrases.

14. The language searching method of claim 13, wherein the articles are shown by using data selected from a group including audio data, explaining material, and video, and the articles in the article database are sorted by topic, area of expertise, and type of dialogue.
